(19) United States
(12) Patent Application Publication
(10) Pub. No.: US 2026/0222960 A1
(43) Pub. Date: Jul. 30, 2026

(54) SELECTION OF A CONDITIONAL SWITCH CONFIGURATION FOR WIRELESS TRANSMIT / RECEIVE UNIT TO NETWORK RELAYS

(71) Applicant: InterDigital Patent Holdings, Inc., Wilmington, DE (US)

(72) Inventors: Martino Freda, Laval (CA); Oumer Teyeb, Montreal (CA); Tuong Hoang, Montreal (CA); Ananth Kini, Conshohocken, PA (US); James Miller, Northport, NY (US); Ghyslain Pelletier, Montreal (CA)

(73) Assignee: InterDigital Patent Holdings, Inc., Wilmington, DE (US)

(21) Appl. No.: 19/148,473

(22) PCT Filed: Feb. 1, 2024
(86) PCT No.: PCT/US2024/013987

§ 371 Date: Jul. 16, 2025

Related U.S. Application Data
(60) Provisional application No. 63/442,935, filed on Feb. 2, 2023.

(51) Int. Cl. H04W 36/36; H04L 1/1812; H04W 8/00; H04W 36/30; H04W 92/18

(52) U.S. Cl. CPC H04W 36/362; H04L 1/1812; H04W 8/005; H04W 36/30; H04W 92/18

(57) ABSTRACT

A wireless transmit/receive unit (WTRU) may be configured to receive a reconfiguration message. The WTRU may be a remote WTRU. The reconfiguration message may be associated with a target. The WTRU may be configured to determine one or more conditions associated with the target. The reconfiguration may be transmitted from a second WTRU. The second WTRU may be a relay WTRU. In some scenarios, the WTRU may be configured to determine whether the target triggers the one or more conditions. The WTRU may be configured to select a target based on the one or more triggered conditions. In some scenarios, the WTRU may be configured to transmit a configuration acknowledgement message based on the selected target.

### CROSS-REFERENCE TO RELATED APPLICATIONS

This application claims the benefit of U.S. Provisional Patent Application No. 63/442,935, filed on Feb. 2, 2023, the entire contents of which are incorporated herein by reference.

### BACKGROUND

In a user equipment (UE)/wireless transmit receive unit (WTRU) to network (U2N) relay architecture, protocol stacks for the Layer 2 (L2) user plane (UP) and control plane (CP) may include sidelink relay adaptation protocol (SRAP) sublayers and/or radio link control (RLC) sublayers. An SRAP sublayer may be placed above the RLC sublayer for CP and/or UP (e.g., in a PC5 interface and/or a Uu interface). Uu service data adaptation protocol (SDAP), packet data convergence protocol (PDCP), and radio resource control (RRC) may be terminated between an L2 U2N Remote WTRU and a base station (e.g., a gNodeB (gNB)). SRAP, RLC, medium access control (MAC) and physical layer (PHY) may be terminated in each hop (e.g., a link between an L2 U2N Remote WTRU and an L2 U2N Relay WTRU, a link between an L2 U2N Relay WTRU and the gNB, etc.).

### SUMMARY

A wireless transmit/receive unit (WTRU) may be configured to receive configuration information. The configuration information may comprise an indication of one or more path switch conditions (e.g., a first path switch condition and a second path switch condition). The WTRU may be a remote WTRU. Each of the one or more path switch conditions may be associated with a target. The WTRU may receive a transmission (e.g., a discovery transmission) from a relay WTRU. The transmission may include an indication of which path switch condition should be applied (e.g., the first or the second path switch condition). The WTRU may determine which path switch condition to apply based on the indication in the received transmission.

The WTRU may be configured to evaluate one or more path switch conditions (e.g., the first path switch condition and/or the second path switch condition). One or more path switch conditions (e.g., the second path switch condition) may be predetermined conditions. The selection of the target may be based on the evaluation of one or more of the path switch conditions (e.g., the first condition and/or the second condition).

In some scenarios, evaluation of the first condition may be based on a PC5 connection with the second WTRU. The second condition may be based on the absence of a PC5 connection with the second WTRU. The one or more conditions may comprise at least one of a mobility, a hybrid automatic repeat request (HARQ) feedback, a channel busy ratio (CBR) measurement, a channel occupancy radio (CR) measurement, and a reference signal received power (RSRP).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a user plane protocol stack for an L2 WTRU-to-Network relay.

FIG. 3 illustrates an example of a control plane protocol stack for an L2 WTRU-to-Network relay.

FIG. 4 illustrates an example of a protocol stack of a discovery message for a WTRU-to-Network relay.

FIG. 5 illustrates an example of a procedure for an L2 U2N remote WTRU switching to a direct Uu cell.

FIG. 6 illustrates an example of a procedure for an L2 U2N remote WTRU switching to an indirect path via an L2 U2N relay WTRU in RRC_CONNECTED.

FIG. 7 illustrates an example of conditional handover configuration and execution.

FIG. 8 illustrates an example of WTRU movement and measurable conditions.

### DETAILED DESCRIPTION

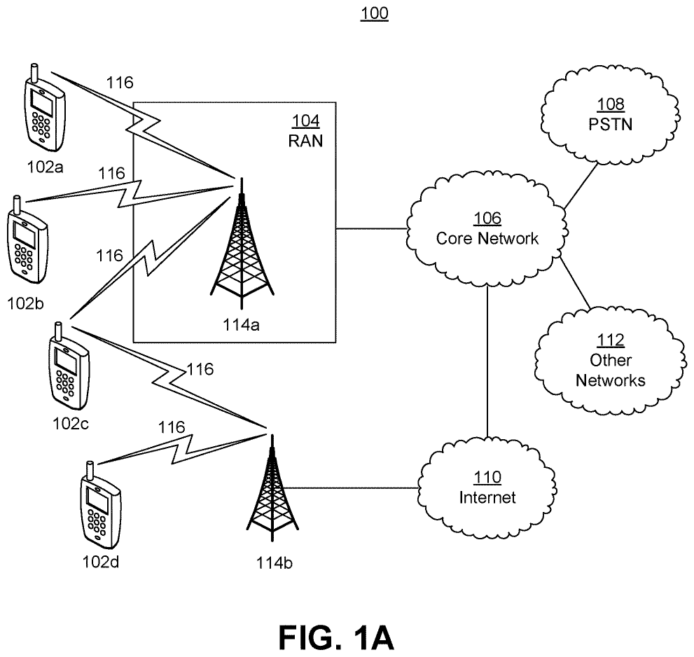

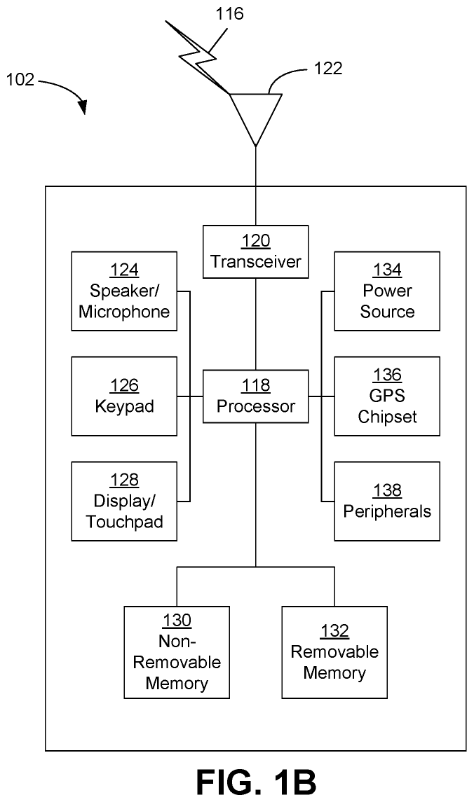

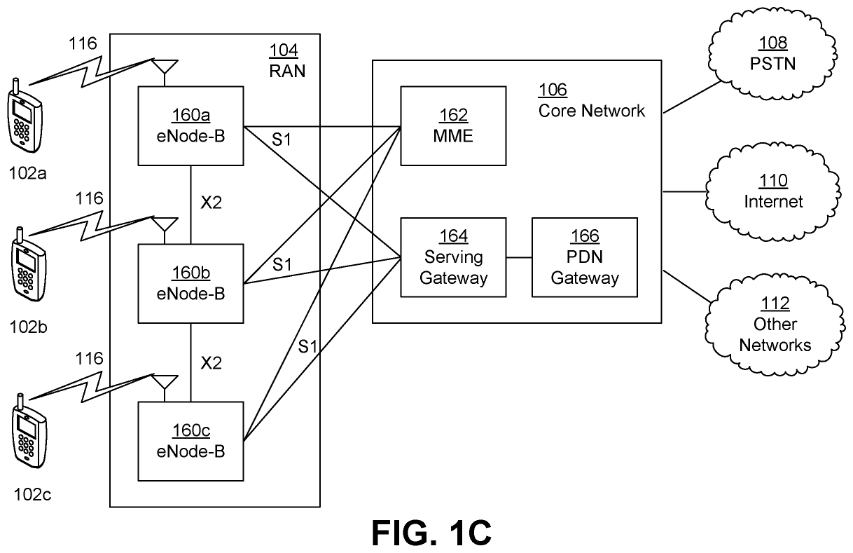

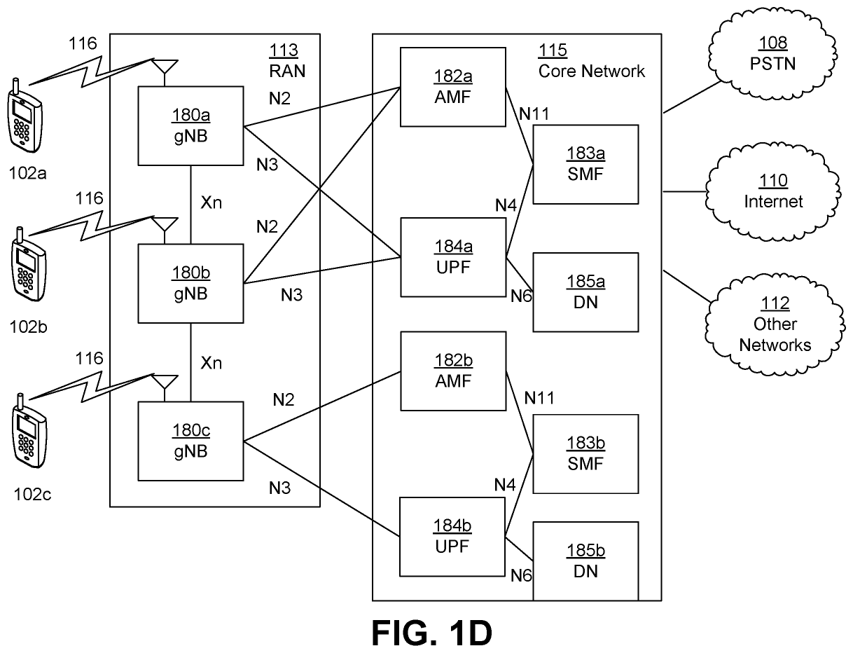

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A sidelink relay adaptation protocol (SRAP) sublayer over PC5 hop may be used for bearer mapping (e.g., for a Layer 2 (L2) UE/WTRU to network (U2N) relay). The SRAP sublayer may not be present over PC5 hop for relaying the L2 U2N Remote WTRU's message on the broadcast control channel (BCCH) and/or the paging control channel (PCCH). The SRAP header may not be present over PC5 hop. For example, for an L2 U2N Remote WTRU's message on signaling radio bearer 0 (SRB0), the SRAP header may not be present over PC5 hop. The SRAP header may be present over Uu hop for DL and/or uplink (UL). For example, SRAP sublayer over PC5 hop may be used for bearer mapping for L2 U2N Remote WTRU's message on SRB0.

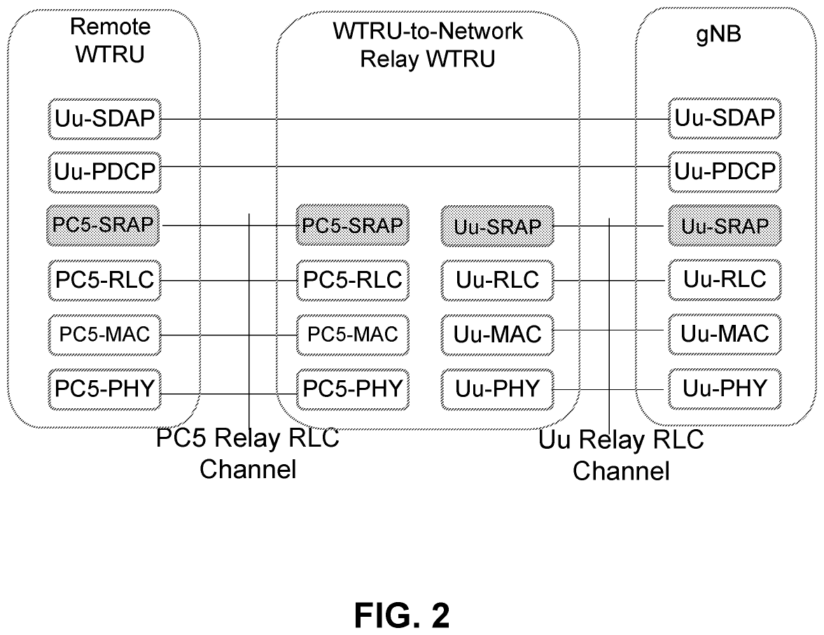

FIG. 2 illustrates an example of a user plane protocol stack for an L2 WTRU-to-Network relay. A user plane protocol stack for a remote WTRU may include one or more of the following: Uu-SDAP; Uu-PDCP; PC5-SRAP; PC5-RLC; PC5-MAC; and/or PC5-PHY. A user plane protocol stack for a WTRU-to-Network relay WTRU may include one or more of the following: PC5-SRAP; Uu-SRAP; PC5-RLC; Uu-RLC; PC5-MAC; Uu-MAC; PC5-PHY; and/or Uu-PHY. A user plane protocol stack for a gNB may include one or more of the following: Uu-SDAP; Uu-PDCP; Uu-SRAP; Uu-RLC; Uu-MAC; and/or Uu-PHY. The Uu-SDAP and/or Uu-PDCP protocols may be terminated between the remote WTRU and the gNB. The Uu-SRAP, Uu-RLC, Uu-MAC, and/or Uu-PHY protocols may be terminated between the WTRU-to-Network relay WTRU and the gNB. The PC5-SRAP, PC5-RLC, PC5-MAC, and/or PC5-PHY protocols may be terminated between the remote WTRU and the WTRU-to-Network relay WTRU.

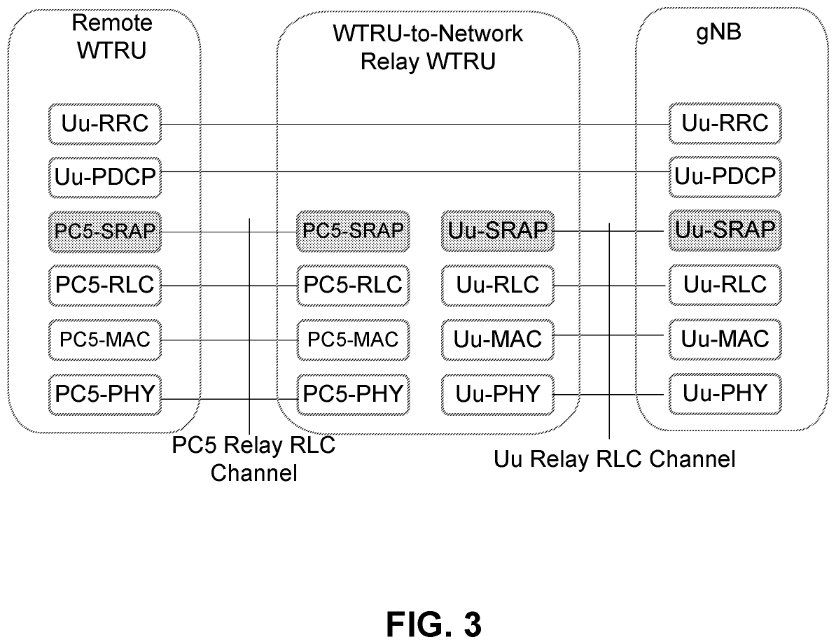

FIG. 3 illustrates an example of a control plane protocol stack for an L2 WTRU-to-Network relay. A control plane protocol stack for a remote WTRU may include one or more of the following: Uu-RRC, Uu-PDCP, PC5-SRAP, PC5-RLC, PC5-MAC, and/or PC5-PHY. A control plane protocol stack for a WTRU-to-Network relay WTRU may include one or more of the following: PC5-SRAP; Uu-SRAP; PC5-RLC; Uu-RLC; PC5-MAC; Uu-MAC; PC5-PHY; and/or Uu-PHY. A control plane protocol stack for a gNB may include one or more of the following: Uu-RRC; Uu-PDCP; Uu-SRAP; Uu-RLC; Uu-MAC; and/or Uu-PHY. The Uu-RRC and/or Uu-PDCP protocols may be terminated between the remote WTRU and the gNB. The Uu-SRAP, Uu-RLC, Uu-MAC, and/or Uu-PHY protocols may be terminated between the WTRU-to-Network relay WTRU and the gNB. The PC5-SRAP, PC5-RLC, PC5-MAC, and/or PC5-PHY protocols may be terminated between the remote WTRU and the WTRU-to-Network relay WTRU.

A remote WTRU may be configured with one or more conditional reconfiguration conditions for a target. In examples, the remote WTRU may receive configuration information (e.g., from a gNB, a relay WTRU, etc.). The configuration information may include an indication of one or more path switch conditions (e.g., a first path switch condition, a second path switch condition, and so on). In some embodiments, the path switch condition(s) may comprise one or more thresholds (e.g., RSRP, RSSI, and/or RSRQ thresholds). The remote WTRU may determine which conditional reconfiguration (e.g., path switch) condition(s) to use (e.g., based on configuration information received from a relay WTRU). A relay WTRU may determine information to transmit to the remote WTRU. The remote WTRU may determine the conditional reconfiguration condition to use based on measurements at the remote WTRU (e.g., associated with the relay). Additionally, or alternatively, a WTRU (e.g., the remote WTRU) may determine one or more conditions based on one or more measurement events, as described herein. Remote WTRU actions may be associated with prioritization of a reconfiguration candidate. The remote WTRU may use criteria for prioritization of one or more reconfiguration candidates.

An SRAP sublayer over PC5 hop may be used for bearer mapping (e.g., for L2 U2N Relay). The SRAP sublayer may not be present over PC5 hop. For example, the SRAP sublayer may not be present over PC5 hop for relaying the L2 U2N Remote WTRU's message on BCCH and/or PCCH. The SRAP header may not be present over PC5 hop. For example, the SRAP header may not be present over PC5 hop for L2 U2N Remote WTRU's message on SRB0. The SRAP header may be present over Uu hop for DL and/or UL.

Relay discovery may be used in a WTRU to network (NW) relay. In examples, a remote WTRU may receive a transmission (e.g., a discovery transmission) including an indication that the remote WTRU should use of one or more path switch conditions (e.g., a first path switch condition and/or a second path switch condition). A remote WTRU may use relay discovery in a WTRU to network NW relay to perform relay selection (e.g., when in RRC_IDLE/RRC_INACTIVE). For example, the remote WTRU may determine to use one more path switch conditions (e.g., a first path switch condition, a second path switch condition, etc.) based on an indication in a transmission (e.g., a discovery transmission). Alternatively, or additionally, discovery may be used in a WTRU to NW relay for a remote WTRU to send measurements of potential relays to the network (e.g., for a remote WTRU in RRC_CONNECTED). Discovery may be used for path switch decisions (e.g., potential path switch decisions). For example, an indication in a discovery transmission may indicate that the remote WTRU should use one or more particular path switch conditions based on whether or not a condition is met. Additionally, or alternatively, a discovery transmission may include an explicit indication that the remote WTRU should use one or more particular path switch conditions (e.g., a first path switch condition and/or a second path switch condition). Discovery may be used for path switch decisions (e.g., potential path switch decisions) by the network.

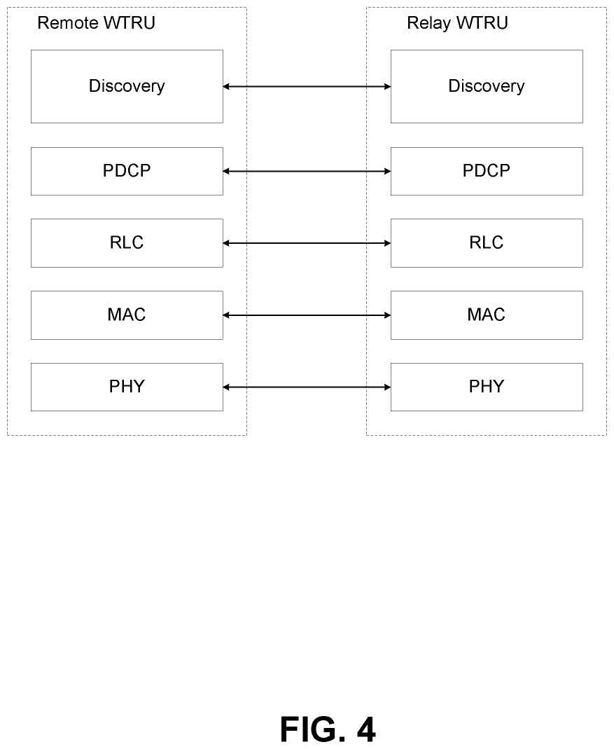

U2N Relay discovery may support discovery models (e.g., Model A and/or Model B). FIG. 4 shows an example of a protocol stack that may be used for discovery. The protocol stack for each of the remote WTRU and the relay WTRU may include the following protocols, and each such protocol may be terminated between the remote WTRU and the relay WTRU: Discovery; PDCP; RLC; MAC; and/or PHY.

The U2N Remote WTRU may perform Relay discovery message transmission and/or monitor the sidelink for Relay discovery messages (e.g., while the U2N remote WTRU is in RRC_IDLE, RRC_INACTIVE and/or RRC_CONNECTED). The network may broadcast and/or configure via dedicated RRC signaling a Uu reference signal received power (RSRP) threshold. The Uu RSRP threshold may be used by the U2N Remote WTRU (e.g., to determine if the U2N Remote WTRU may transmit one or more Relay discovery messages to one or more U2N Relay WTRU(s)).

The U2N Relay WTRU can perform Relay discovery message transmission and monitor the sidelink for Relay discovery message while in RRC_IDLE, RRC_INACTIVE and/or RRC_CONNECTED. The network may broadcast or configure a Uu RSRP threshold (e.g., a maximum Uu RSRP threshold, a minimum Uu RSRP threshold, or both), via dedicated RRC signaling. The configured Uu RSRP threshold(s) may be used by the U2N Relay WTRU to determine if it can transmit Relay discovery messages to U2N Remote WTRU(s).

The network may provide the Relay discovery configuration using broadcast and/or dedicated signaling (e.g., for Relay discovery). Alternatively, or additionally, the U2N Remote WTRU and/or U2N Relay WTRU may use pre-configuration for Relay discovery.

One or more measurement events may be used in a U2N relay system. Measurement events may be in Uu and/or for SLR. Radio resource management (RRM) measurements may be triggered by measurement events configured at the WTRU (e.g. based on RSRP measurement, reference signal received quality (RSRQ) measurement, etc.). Alternatively, or additionally, conditional handover, may be triggered by measurement events configured at the WTRU (e.g., based on RSRP measurement, RSRQ measurement, etc.). Examples of measurement events that may be configured by the network (e.g., both for the case of measurement reporting, and for conditional reconfiguration) include but are not limited to: when serving exceeds an absolute threshold (herein, A1); when serving is less than an absolute threshold (herein, A2); when a neighbor becomes better than PCell/PSCell by an amount of offset (herein, A3); when a neighbor exceeds an absolute threshold (herein, A4); when PCell/PSCell is less than an absolute threshold (e.g., threshold1) and Neighbor/SCell exceeds a second absolute threshold (herein, A5); when a neighbor becomes amount of offset better than SCell (herein, A6); when a PCell/PSCell is less than an absolute threshold and conditional reconfiguration candidate exceeds a second absolute threshold (e.g., A5); when serving an L2 U2N Relay WTRU is less than an absolute threshold and NR Cell exceeds a second absolute threshold (herein, X1); and/or when serving an L2 U2N Relay WTRU is less than an absolute threshold (herein, X2).

There may be mobility in WTRU to NW relays. A service continuity procedure may be applicable for the mobility cases of path switch from indirect to direct path, and/or from direct to indirect path (e.g., when the L2 U2N Remote WTRU and L2 U2N Relay WTRU belong to the same gNB). Other cases, including indirect to indirect; and/or direct to indirect; and/or indirect to direct for different gNB may additionally, or alternatively be supported.

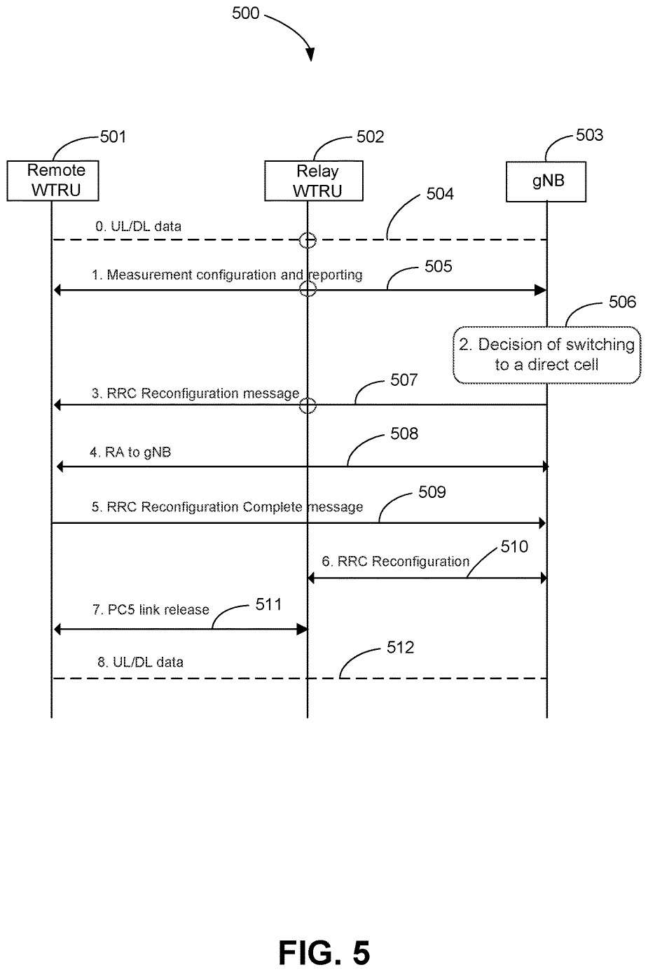

Procedures may be used to enable service continuity when a WTRU using an L2 U2N Relay switches paths (e.g., in case of L2 U2N Remote WTRU switching to direct path). FIG. 5 illustrates an example procedure 500 for an L2 U2N remote WTRU switching to a direct Uu cell. At 504, a remote WTRU 501 may transmit UL data and/or receive DL data to/from a gNB 503 via a relay WTRU 502. At 505, the remote WTRU 501 may send/receive measurement configuration and reporting to/from the gNB 503 via a relay WTRU 502. At 506, the gNB 503 may decide to switch the remote WTRU 501 to a direct cell. At 507, the gNB 503 may send an RRC Reconfiguration Message to the remote WTRU 501 via the relay WTRU 502. At 508, the remote WTRU 501 may perform random access with the gNB 503. At 509, the remote WTRU 501 may send an RRC Reconfiguration complete message to the gNB 503. At 510, the gNB 503 and the relay WTRU 502 may perform RRC reconfiguration. At 511, the remote WTRU 501 and the relay WTRU 502 may perform PC5 link release. At 512, the remote WTRU 501 may transmit UL data and/or receive DL data to/from a gNB 503 via a direct cell connection.

The L2 U2N Remote WTRU may perform measurements according to its Uu measurement configuration. The L2 U2N Remote WTRU may perform measurement report signaling procedures (e.g., to evaluate relay link measurement and/or Uu link measurements). The L2 U2N Remote WTRU may report measurement results (e.g., when configured measurement reporting criteria are met). The sidelink relay measurement report may include one or more of an L2 U2N Relay WTRU's source L2 identifier (ID), a serving cell ID (e.g., new radio cell global identity (NCGI); new radio cell identity (NCI); etc.), and/or a sidelink measurement quantity result. The sidelink measurement quantity may be SL-RSRP of the serving L2 U2N Relay WTRU. Additionally, or alternatively, the sidelink measurement quantity may be SD-RSRP. The gNB may decide to switch the L2 U2N Remote WTRU onto a direct Uu path.

The gNB may transmit an RRCReconfiguration message to the L2 U2N Remote WTRU. The L2 U2N Remote WTRU may stop UP and/or CP transmission via the L2 U2N Relay WTRU (e.g., after reception of the RRCReconfiguration message with the path switch configuration). The L2 U2N Remote WTRU may synchronize with the gNB. The L2 U2N remote WTRU may perform Random Access. The WTRU (e.g., the L2 U2N Remote WTRU) may transmit the RRCReconfigurationComplete message to the gNB (e.g., via the direct path), using the configuration provided in the RRCReconfiguration message. The WTRU (e.g., the L2 U2N Remote WTRU) may use the RRC connection (e.g., via the direct path to the gNB). The gNB may transmit an RRCReconfiguration message to the L2 U2N Relay WTRU (e.g., to reconfigure the connection between the L2 U2N Relay WTRU and the gNB). The RRCReconfiguration message to the L2 U2N Relay WTRU may be transmitted based on gNB implementation (e.g., to release Uu and PC5 Relay RLC channel configuration for relaying, and/or bearer mapping configuration related to the L2 U2N Remote WTRU). The gNB may transmit the RRCReconfiguration message to the L2 U2N Relay WTRU at any time (e.g., after the gNB transmits the RRCReconfiguration message to the L2 U2N Remote WTRU). The L2 U2N Relay WTRU's and/or the L2 U2N Remote WTRU's access stratum (AS) layers may release PC5-RRC connection and/or indicate upper layers to release PC5 unicast link (e.g., after receiving the RRCReconfiguration message from the gNB). Timing to execute link release may be up to WTRU implementation.

The data path may be switched from indirect path to direct path between the WTRU (e.g., the previous L2 U2N Remote WTRU) and the gNB. The WTRU (e.g., the L2 U2N remote WTRU) may perform PDCP re-establishment and/or PDCP data recovery in uplink. The data path may be switched from indirect path to direct path between the WTRU (e.g., the previous L2 U2N Remote WTRU) and the gNB. The WTRU (e.g., the L2 U2N Remote WTRU) may perform PDCP re-establishment and/or PDCP data recovery in uplink for lossless delivery during path switch if the gNB configures it. Data path switching may be executed at any time (e.g., after the L2N Remote WTRU synchronizes with the gNB and/or performs Random Access). Data path switching may be independent from the gNB transmitting the RRCReconfiguration message to the L2 U2N Relay WTRU. Data path switching may be independent from the L2 U2N Relay WTRU's and/or L2 U2N Remote WTRU's AS layer releasing the PC5-RRC connection and/or indicating upper layers to release PC5 unicast link.

The data path may be switched from a direct path to an indirect path. The gNB may select a L2 U2N Relay WTRU in any RRC state (e.g., RRC_IDLE, RRC_INACTIVE, and/or RRC_CONNECTED). The gNB may select a L2 U2N Relay WTRU in any RRC state as a target L2 U2N Relay WTRU for direct to indirect path switch.

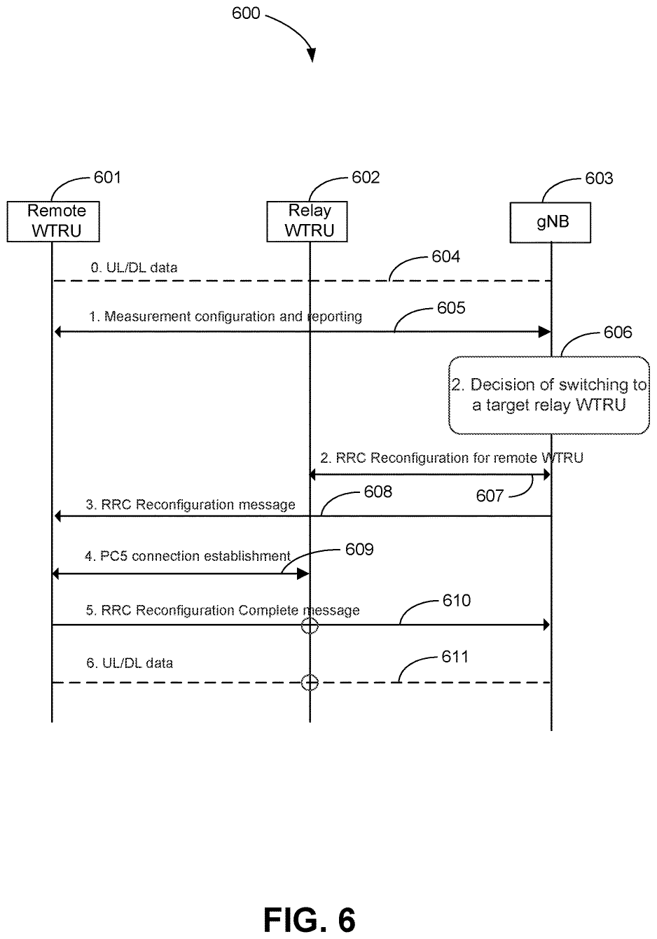

Procedures may be used to enable service continuity when a WTRU switches paths (e.g., in case of an WTRU switching to an indirect path via an L2 U2N Relay WTRU in RRC_CONNECTED). FIG. 6 illustrates an example of a procedure for an L2 U2N remote WTRU switching to an indirect path via an L2 U2N relay WTRU in RRC_CONNECTED at 600. At 604, a remote WTRU 601 may transmit UL data and/or receive DL data to/from a gNB 603 via a direct cell connection. At 605, the remote WTRU 501 may send/receive measurement configuration and reporting to/from the gNB 503 via a direct cell connection. At 606, the gNB 503 may decide to switch the remote WTRU 601 to use a target relay WTRU 602. At 607, the gNB 603 and the relay WTRU 602 may perform RRC reconfiguration for the remote WTRU 601. At 608, the gNB 603 may send an RRC reconfiguration message to the remote WTRU 601. At 609, the remote WTRU 601 and the relay WTRU 602 may perform PC5 connection establishment. At 610, the remote WTRU 601 may send an RRC Reconfiguration Complete message to the gNB 603 via the relay WTRU 602. At 611, the remote WTRU 601 may transmit UL data and/or receive DL data to/from a gNB 603 via the relay WTRU 602.

The L2 U2N Remote WTRU may report one or more candidate L2 U2N Relay WTRU(s) and/or Uu measurements (e.g., after the Remote WTRU measures/discovers the candidate L2 U2N Relay WTRU(s)). The L2 U2N Remote WTRU may filter the L2 U2N Relay WTRU(s) according to relay selection criteria before reporting (e.g., appropriate L2 U2N Relay WTRU(s). The L2 U2N Remote WTRU may report the L2 U2N Relay WTRU candidate(s) that fulfill(s) higher layer criteria (e.g., only the L2 U2N Relay WTRU candidate(s) that fulfill(s) higher layer criteria). The reporting may include one or more of an L2 U2N Relay WTRU ID, a L2 U2N Relay WTRU's serving cell ID, and/or a sidelink measurement quantity information. SD-RSRP may be used as sidelink measurement quantity.

The gNB may decide to switch the L2 U2N Remote WTRU to a target L2 U2N Relay WTRU. The gNB may transmit RRCReconfiguration message to the target L2 U2N Relay WTRU (e.g., after the gNB decides to switch the L2 U2N Remote WTRU to a target L2 U2N Relay WTRU). The RRCReconfiguration message may include one or more of the L2 U2N Remote WTRU's local ID/L2 ID, Uu and PC5 Relay RLC channel configuration for relaying, and/or bearer mapping configuration. The gNB may transmit a RRCReconfiguration message to the L2 U2N Remote WTRU. The RRCReconfiguration message that the gNB transmits to the L2 U2N Remote WTRU may be the same message or a different RRCReconfiguration message than the RRCReconfiguration message the gNB transmitted to the L2 U2N target WTRU. The RRCReconfiguration message that the gNB transmits to the L2 U2N remote WTRU may include one or more or the L2 U2N Relay WTRU ID, Remote WTRU's local ID, PC5 Relay RLC channel configuration for relay traffic and/or the associated end-to-end radio bearer(s). The L2 U2N Remote WTRU may stop UP and/or CP transmission (e.g., over the direct path after reception of the RRCReconfiguration message from the gNB). The L2 U2N Remote WTRU may establish PC5 RRC connection with target L2 U2N Relay WTRU. The L2 U2N Remote WTRU may complete the path switch procedure by sending the RRCReconfigurationComplete message to the gNB (e.g., via the L2 U2N Relay WTRU). The data path may be switched from direct path to indirect path between the L2 U2N Remote WTRU and the gNB.

The L2 U2N Remote WTRU may establish a PC5 link with the L2 U2N Relay WTRU and/or may transmit the RRCReconfigurationComplete message (e.g., via the L2 U2N Relay WTRU). If the selected L2 U2N Relay WTRU for direct to indirect path switch is in RRC_IDLE or RRC_INACTIVE, the L2 U2N Remote WTRU may establish a PC5 link with the L2 U2N Relay WTRU and/or may transmit the RRCReconfigurationComplete message (e.g., via the L2 U2N Relay WTRU). The L2 U2N Remote WTRU may establish a PC5 link with the L2 U2N Relay WTRU and/or may transmit the RRCReconfigurationComplete message, (e.g., after receiving the path switch command). The establishment of the PC5 link and/or path switch command may trigger the L2 U2N Relay WTRU to enter RRC_CONNECTED state. A procedure for L2 U2N Remote WTRU switching to indirect path may be additionally, or alternatively, be applied for the case that the selected L2 U2N Relay WTRU for direct to indirect path switch is in RRC_IDLE or RRC_INACTIVE (e.g., with the exception that the RRCReconfiguration message may be transmitted from the gNB to the L2 U2N Relay WTRU after the L2 U2N Relay WTRU enters RRC_CONNECTED state). The gNB may transmit an RRCReconfiguration message to the L2 U2N Relay WTRU after the L2 U2N Relay WTRU enters RRC_CONNECTED state (e.g., during the time between when the L2 U2N Remote WTRU establishes a PC5 RRC connection with the target L2 U2N Relay WTRU and when the L2 U2N Remote WTRU completes the path switch procedure by transmitting the RRCReconfigurationComplete message to the gNB via the L2 U2N Relay WTRU).

There may be conditional handover (HO) in Uu. Conditional handover (CHO) and/or conditional PSCell Addition/Change (CPA/CPC, or collectively referred to as CPAC) may reduce the likelihood of radio link failures (RLF) and handover failures (HOF). LTE/NR handover may be triggered by measurement reports (e.g., even though there is nothing preventing the network from sending a HO command to the WTRU even without receiving a measurement report). For example, the WTRU may be configured with an A3 event that triggers a measurement report to be transmitted when the radio signal level/quality (e.g., RSRP, RSRQ, etc.) of a neighbor cell exceeds than the Primary serving cell (PCell) and/or the Primary Secondary serving Cell (PSCell) (e.g., in the case of Dual Connectivity (DC)). The WTRU may monitor the serving and/or neighbor cells. The WTRU may transmit a measurement report when one or more of the conditions are fulfilled. When a report is received, the network (e.g., a current serving node/cell) may prepare the HO command (e.g., an RRC Reconfiguration message, with a reconfigurationWithSync) and/or transmit the HO command to the WTRU. The WTRU may execute the HO command. For example, the WTRU may execute the HO command immediately resulting in the WTRU connecting to the target cell.

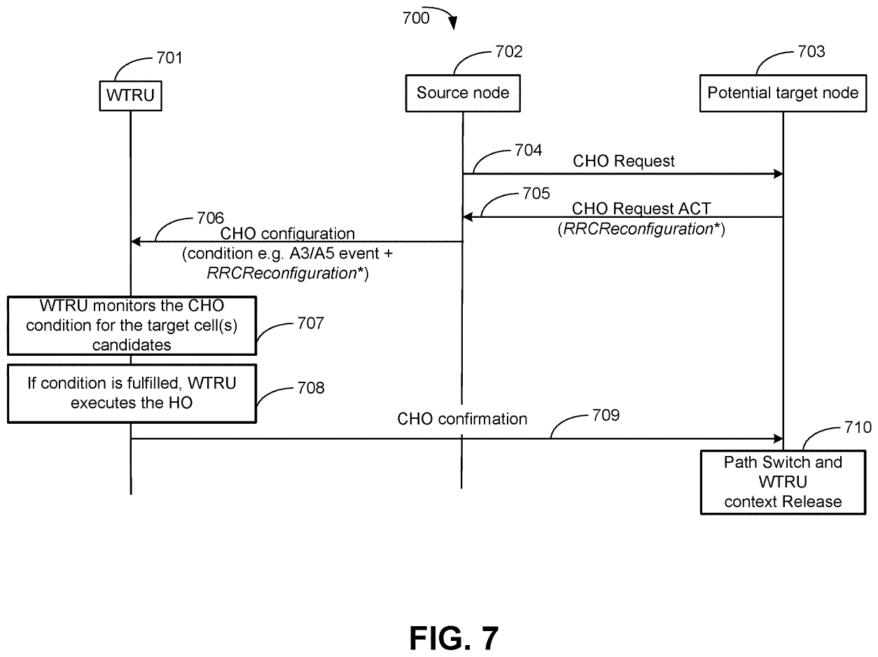

FIG. 7 illustrates an example of conditional handover configuration and execution at 700. At 704, a source node 702 may send a CHO request to a potential target node 703. At 705, the potential target node 703 may send a CHO Request ACK (RRCReconfiguration*) to the source node 702. At 706, the source node may send a CHO configuration (e.g., including a condition such as an A3/A5 event and an RRC reconfiguration) to a WTRU 701. At 707, the WTRU 701 may monitor the CHO condition for the target cell(s) candidates. At 708, if the condition is fulfilled, the WTRU 701 may execute the HO. At 709, the WTRU 701 may transmit a CHO confirmation to the potential target node 703. At 710, the potential target node may perform a path switch and WTRU context release.

CHO may differ from other handovers. In CHO, multiple handover targets may be prepared (e.g., as compared to only one target in legacy HO case). The WTRU may not immediately execute the CHO as in the case of the legacy handover. The WTRU may be configured with triggering conditions (e.g., a set of radio conditions). The WTRU may execute the handover towards one of the targets when/if the triggering conditions are fulfilled (e.g., only when/if the triggering conditions are fulfilled).

The CHO command may be transmitted when the radio conditions towards the current serving cells are still favorable, thereby reducing one or more of the main risks of failure in legacy handover (e.g., the risk of failing to send the measurement report). Legacy handover may alternatively, or additionally, fail if the link quality to the current serving cell falls below acceptable levels when the measurement reports are triggered in normal handover. Legacy handover may alternatively, or additionally, fail if there is failure to receive the handover command (e.g. if the link quality to the current serving cell falls below acceptable levels after the WTRU has sent the measurement report, but before the WTRU has received the HO command).

The triggering conditions for a CHO may be based on the radio quality of the serving cells and/or neighbor cells (e.g., like the conditions that are used in legacy NR/LTE to trigger measurement reports). For example, a WTRU may be configured with a CHO that has an A3 like triggering conditions and/or an associated HO command. The WTRU may monitor the current and/or serving cells. The WTRU may, instead of sending a measurement report, execute the associated HO command and/or may switch the connection towards the target cell (e.g., when the A3 triggering conditions are fulfilled).

CHO may help to prevent unnecessary re-establishments in case of a radio link failure (RLF). If a WTRU experiences an RLF failure, legacy operation may result in the WTRU performing an RRC re-establishment procedure that incurs considerable interruption time for the bearers of the WTRU. However, if a WTRU configured with multiple CHO targets experiences an RLF before the triggering conditions with any of the targets gets fulfilled, and the WTRU (e.g., after detecting an RLF), ends up in a cell for which it has a CHO associated with (e.g., the target cell is already prepared for it), the WTRU may execute the HO command associated with this target cell directly (e.g., instead of continuing with the full re-establishment procedure).

CPC and CPA may be extensions of CHO (e.g., in DC scenarios). A WTRU may be configured with triggering conditions for PSCell change and/or addition. For example, when the triggering conditions are fulfilled, the WTRU may execute the associated PSCell change and/or PSCell add commands.

Conditional HO in Uu may be based on the premise that the WTRU can perform HO to a preconfigured target cell when some conditions associated with the source and target cell quality are met. This may avoid having the WTRU transmit measurement reports to the network for the network to make the HO decision (e.g., since the measurement reports or the HO command itself could be degraded/lost, resulting in RLF prior to the execution of the HO).

For a WTRU which can use a sidelink (SL) relay for coverage extension, a path switch may be preconfigured to the WTRU while in coverage (e.g., like Uu conditional HO). The WTRU may base HO decisions on Uu quality of a cell (e.g., in case of current or potential future direct Uu communication) and/or the SL quality of a potential relay. The WTRU may not consider the backhaul (e.g., Uu) link quality. The WTRU (e.g., when considering potential target relay WTRUs associated with a preconfigured SL condition (e.g., SL RSRP>threshold) may not be aware of the Uu link quality.

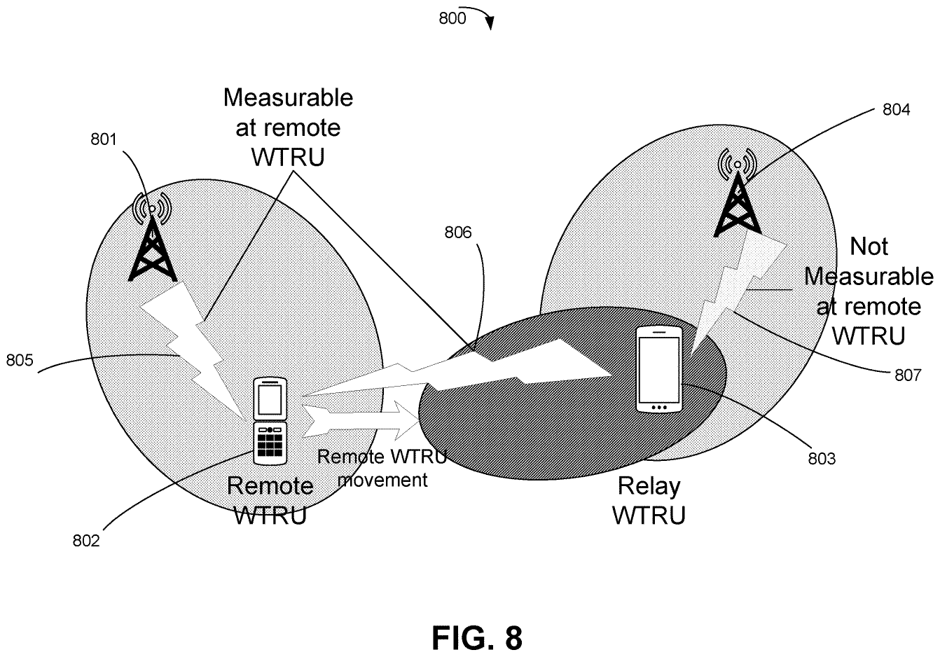

FIG. 8 illustrates WTRU movement and measurable conditions at 800. A first gNB 801 may communicate with a remote WTRU 802 via a Uu interface 805. The remote WTRU 802 may communicate with a relay WTRU 803 via a sidelink connection 806. The relay WTRU 803 may communicate with a second gNB 804 via a Uu connection 807. The remote WTRU 802 may be mobile (e.g., moving relative to first gNB 801, the second gNB 804, and/or the relay WTRU 803). The strength of the Uu connection 807 between the relay WTRU 803 and the second gNB 804 may not be measurable by the remote WTRU 802.

Other criteria which may not be known or controlled by the network may also have an impact on the decision of the handover target relay WTRU. For example, the criteria may include one or more of the measured CBR at the WTRU (e.g., which could change at the time of path switch and/or before), the RRC state of the selected relay, the resource selection mode of the relay, etc. It may not be clear how the network takes this information into account at the time when the conditional HO command is prepared (e.g., since this information may change without the network's knowledge of such).

A remote WTRU may be configured for selection of a conditional switch configuration. A method for a remote WTRU to select between performing the monitoring of different conditional path switch conditions may be based on an indication in the discovery message. A remote WTRU may receive a conditional reconfiguration including a first condition (e.g., one or more Ax conditions and associated thresholds). The first condition may be related to signal quality (e.g., SL-RSRP/SD-RSRP) of a target relay. The remote WTRU may additionally, or alternatively receive a second condition (e.g., one or more Ax conditions and associated thresholds). The second condition may be related to signal quality (e.g., SL-RSRP/SD-RSRP) of a target relay (e.g., the same target relay).

The remote WTRU may monitor discovery transmissions from the target relay. The discovery transmissions may contain an indication type (e.g., an information element (IE) that can take different values). The remote WTRU may determine which of the first condition, and/or the second condition in the conditional reconfiguration to use to determine whether/when to perform conditional reconfiguration to the target (e.g., based on the presence/information in an indication in the discovery transmission by the target relay). For example, the remote WTRU may use the first condition, if the target relay transmits a first indication type. Additionally, or alternatively, the remote WTRU may use the second condition if the target relay transmits a second indication type. The remote WTRU may transmit a reconfigurationComplete message (e.g., via the target relay). For example, if the condition selected by the remote WTRU is met, the remote WTRU may transmit a reconfigurationComplete message via the target relay.

A wireless transmit/receive unit (WTRU) may be configured to receive a reconfiguration message. The WTRU may be a remote WTRU. The reconfiguration message may be associated with a target. The WTRU may be configured to determine one or more conditions associated with the target. The reconfiguration may be transmitted from a second WTRU. The second WTRU may be a relay WTRU. In some scenarios, the WTRU may be configured to determine whether the target triggers the one or more conditions. The WTRU may be configured to select a target based on the one or more triggered conditions. In some scenarios, the WTRU may be configured to transmit a configuration acknowledgement message based on the selected target.

The WTRU may be configured to evaluate a first condition and a second condition from the one or more conditions. The one or more conditions associated with the target may comprise a first path switch condition, and a second condition, the first path switch condition based on the second condition. For example, the second condition may be a predetermined condition. The selection of the target may be based on the evaluation of the first condition and the second condition.

In some scenarios, evaluation of the first condition may be based on a PC5 connection with the second WTRU. The second condition may be based on the absence of a PC5 connection with the second WTRU. The one or more conditions may, in examples, may comprise or be related to one or more of: the load of the relay WTRU, a measurement of a Uu interface associated with the relay WTRU, a mobility state (e.g., of the relay WTRU), a hybrid automatic repeat request (HARQ) feedback, a channel busy ratio (CBR) measurement (e.g., of the relay WTRU), a channel occupancy radio (CR) measurement, and a reference signal received power (RSRP).

A WTRU may be configured to prioritize reconfiguration candidates. A method for a remote WTRU to determine the priority of a conditional reconfiguration candidate relay may be based on a time duration between the reception of the configuration and the fulfillment of one or more triggering condition(s) for the configuration. In examples, a WTRU may receive configuration information which comprises a measurement condition associated with a relay WTRU. The WTRU may determine whether or not the measurement condition is satisfied. The WTRU may determine a priority associated with the relay WTRU based on a time between when the configuration information was received, and when the measurement condition was satisfied.

A remote WTRU may receive a conditional reconfiguration comprising a candidate relay and/or a corresponding condition related to a quality (e.g., SL-RSRP) of the candidate relay. A remote WTRU may determine a priority of a candidate relay that triggers the condition based on the time between configuration of the candidate and fulfillment of the triggering condition(s) (e.g., longer time=lower priority). The remote WTRU may select the candidate relay with the highest determined priority (e.g., if multiple candidate relays trigger a conditional reconfiguration). The remote WTRU may transmit a reconfigurationComplete message via the selected target relay (e.g., if multiple candidate relays trigger a conditional reconfiguration).

A wireless transmit/receive unit (WTRU) may be configured to receive one or more reconfiguration messages. The WTRU may be a remote WTRU. The one or more reconfiguration messages may comprise (e.g., may each comprise) a candidate and one or more conditions associated with the candidate. The WTRU may be configured to determine whether each candidate triggers the one or more conditions. The WTRU may be configured to determine a priority of each candidate that triggers the one or more conditions. In some scenarios, the WTRU may be configured to select a highest priority candidate among the candidates that trigger the one or more conditions. The WTRU may be configured to transmit a configuration acknowledgement message. The configuration acknowledgement message may be based on the highest priority candidate.

The WTRU may be configured to add an offset to the candidate. The selection of the highest priority candidate may be based on the offset. The WTRU may be configured to monitor the one or more conditions with one or more periodicities. In some scenarios, the WTRU may be configured to determine whether to maintain a candidate. The determination of whether to maintain a candidate may be made following a path switch. The WTRU may be configured to determine the priority based on the candidate being a cell or a relay.

The one or more conditions may comprise at least one of a mobility, a quality, and a reference signal received power (RSRP). Alternatively, or additionally, the one or more conditions may comprise a duration between receipt of the reconfiguration message and triggering of the one or more conditions. The duration may be based on at least one of a mobility, a quality, and a reference signal received power (RSRP).

A reconfiguration candidate discussed herein may include the target of a conditional reconfiguration command. A reconfiguration candidate may be either a cell (e.g., for path switch of a remote WTRU directly to a Uu link) and/or a relay (e.g., for path switch of a remote WTRU to a relay WTRU). A conditional reconfiguration may comprise a CHO-like command (e.g., which could contain cells and/or relays).

The term condition herein may refer to a threshold (e.g., an SL-RSRP/SD-RSRP threshold). The threshold may be an absolute threshold (e.g., SL-RSRP between the remote WTRU and the target relay WTRU is above the threshold) and/or a relative threshold (e.g., SL-RSRP between the remote WTRU and the target relay WTRU is above the SL-RSRP between the remote WTRU and the current serving SL relay).

Determining the condition to be fulfilled, as herein, may refer to different things. For example, the WTRU may be configured with a condition (e.g., A3), and/or may use different thresholds depending on the indication from one or more relay(s). For example, for a first indication, the condition to be fulfilled may be the evaluation of A3 with the first threshold; and/or for a second indication, the condition to be fulfilled may be the evaluation of A3 with a second threshold. In some embodiments, for a first indication, a first set (e.g., threshold1/first threshold and threshold2/second threshold) may be used in evaluating X1, and/or for a second indication, a second set (e.g., threshold1/first threshold and threshold2/second threshold) may be used in evaluating X1. Alternatively, or additionally, the condition may refer to one or more of evaluating two different conditions, evaluating one or more conditions, and/or evaluating conditions of the same type. For example, for a first indication, an A3 condition may be evaluated, and/or for a second indication, an A5 condition may be evaluated. For example, for a first indication, an X1 condition may be evaluated and/or for a second indication, an X2 condition may be evaluated. Alternatively, or additionally, for first indication, the WTRU may use a first value of a time to trigger (TTT) to determine whether to trigger the event, and/or for a second indication, the WTRU may use a second value of the TTT. Alternatively, or additionally, for a first indication, the WTRU may evaluate one measurement (e.g., RSRP) when performing the measurements for event evaluation, and/or for a second indication, the WTRU may use the same measurement or a different measurement (e.g., RSRQ). Herein, evaluated/fulfilled may be used interchangeably, and/or in each instance, the solution may refer to both cases. The terms conditional reconfiguration, conditional handover, and conditional path switching may be used interchangeably herein.

When the source gNB generates a conditional reconfiguration command some conditions (e.g., the Uu measurements of the relay WTRU, the load of the relay WTRU, etc.) may change without the source gNB being aware of such. Hence, the gNB may not be able to modify the conditional reconfiguration to account for changes to some conditions. Additionally, or alternatively, the relay WTRU may be under the control of a different gNB compared to the remote WTRU (e.g., during a path switch triggered by a conditional reconfiguration). In some scenarios, there may be a need to handle different potential outcomes, environment, measurements, etc., differently at the remote WTRU. the relay WTRU may transmit information to the remote WTRU. For example, the information may be sent in one or more of the following: a discovery message, a PC5-RRC message, a SL MAC CE, Encapsulated into the data (e.g., in a protocol header), in a sidelink control information (SCI). The remote WTRU may use the transmitted information.

A remote WTRU may be configured with multiple conditional reconfiguration conditions for the same target. The remote WTRU may receive a conditional reconfiguration command in an RRC reconfiguration. The conditional reconfiguration may represent a CHO and/or a conditional path switch command. The conditional reconfiguration may include the RRC configuration for one or more target cells, and/or target relays. One or more target cells (e.g., each target cell) or target relay may be configured with one or more conditions. The one or more conditions, when satisfied, may trigger the remote WTRU to initiate reconfiguration for that target (e.g., thus performing HO or path switch to that target).

The remote WTRU may be configured with multiple conditions associated with a single target. The remote WTRU may select one or more specific condition(s) (e.g., CHO and/or path switch conditions). The one or more condition may be used and/or fulfilled when determining whether to perform the CHO or path switch based on another condition (e.g., the CHO/path switch selection condition). Another (e.g., the other) condition (e.g., the CHO/path switch selection condition) may be predetermined in the specification. Alternatively, or additionally, the condition and/or the other condition may be configured by the network. For example, the condition and/or the other condition may be configured by the network, as part of the CHO and/or conditional reconfiguration command, and/or in a separate configuration.

A remote WTRU may determine the conditional reconfiguration condition to use based on information received from a relay WTRU. The remote WTRU configured with multiple conditions for performing a conditional reconfiguration may determine one or more specific condition to be fulfilled based on information received from a relay WTRU. In some embodiments, a relay WTRU may provide information to the remote WTRU. Based on the information provided, the remote WTRU may to select one or more condition(s) for use in determining when to trigger a reconfiguration. The relay WTRU providing the information may be the same relay WTRU associated with the target of the reconfiguration. Alternatively, or additionally, the relay WTRU providing the information may be the same as the relay WTRU associated with source of the reconfiguration (e.g., the relay WTRU to which the remote WTRU is attached at the time the conditions are fulfilled). Alternatively, or additionally, the remote WTRU may receive one or more indications from different relays (e.g., an indication from the source and an indication from a potential target). The indications may (e.g., in combination) be used to determine the condition to be fulfilled.

Information transmitted by a relay may be used to determine whether a remote WTRU evaluates a condition associated with a conditional reconfiguration (e.g., where the target is the relay itself). Information from the relay WTRU may be received by the remote WTRU, including but not limited to for one or more of the following. The remote WTRU may receive information from the relay WTRU in PC5-RRC signaling (e.g., where a remote WTRU has a PC5-RRC connection with the relay WTRU). The remote WTRU may receive information from the relay WTRU in the discovery transmission performed by the relay WTRU. The remote WTRU may receive information from the relay WTRU in a SL MAC CE transmitted by the relay (e.g., where a remote WTRU has a PC5-RRC connection with the relay WTRU). The remote WTRU may receive information from the relay WTRU in a PHY layer transmission by the relay WTRU (e.g., an SCI transmission). Additionally, or alternatively, the remote WTRU may receive information from the relay WTRU in a data transmission received from the relay WTRU (e.g. in SL data).

The information received from the relay WTRU may include one or more of the following: an explicit and/or implicit indication, index, or value; an indication that a PC5-RRC connection with the relay WTRU is present; an indication that a relationship exists between the current serving cell and the serving cell of the relay; and/or a measurement value (e.g., RSRP, RSRQ, RSSI) transmitted by the relay WTRU.

The information received from the relay WTRU may include an exploit and or implicit indication, index, or value. For example, a relay WTRU may transmit an index and/or value (e.g., in case of multiple conditions) in a message (e.g., in the discovery message). A remote WTRU may be configured with an indexed list of conditions associated with a conditional reconfiguration target. The remote WTRU may determine which condition to evaluate when determining whether to trigger the conditional reconfiguration based on a corresponding index transmitted (e.g., in the discovery message) by the corresponding target relay. In some scenarios, the remote WTRU may select the condition in the list of conditions with an index that matches an index in the discovery message. For example, a relay WTRU may transmit a one-bit indication in a message (e.g., in the discovery message).

The remote WTRU may be configured with a plurality of (e.g., two) separate conditions and may evaluate a first condition for determining whether to initiate a conditional reconfiguration when the indication is present in the discovery message, and/or may evaluate a second condition when the indication is not present. For example, a relay WTRU may transmit a one-bit indication in a message (e.g., in the discovery message). A remote WTRU may be configured with a condition for determining whether to initiate conditional reconfiguration to the target relay WTRU. If the relay WTRU sends the indication, the remote WTRU may evaluate the condition and/or perform conditional reconfiguration when the condition is met. In some scenarios, if the relay WTRU does not send the indication, the remote WTRU may disable evaluation of the condition and/or not perform the configured conditional reconfiguration. A relay WTRU may implicitly indicate the index of the condition to be used by the remote WTRU. The remote WTRU may select a first condition and/or a second condition. The remote WTRU may select a first condition and/or a second condition depending on whether the relay sends a measurement (e.g., Uu RSRP) in the discovery message. The remote WTRU may select a first condition and/or a second condition depending on how the discovery message is sent (e.g., whether the resource pool is shared or dedicated, the frequency of the discovery message transmission, etc.) A relay WTRU may not transmit an index (e.g., any index). In some scenarios, the remote WTRU may be configured with a default index associated with the conditions to use.

The information received from the relay WTRU may include an indication that a PC5-RRC connection is present with the relay WTRU. In some embodiments, a remote WTRU may evaluate a first condition when the remote WTRU has a PC5-RRC connection with the relay WTRU, and/or may evaluate a second condition when the remote WTRU does not have a PC5-RRC connection with the relay WTRU.

The information received from the relay WTRU may include an indication that a relationship exists between the current serving cell and the serving cell of the relay. In some embodiments, a remote WTRU may evaluate a first condition when the remote WTRU's current serving cell is the same (e.g., or part of the same related group of cells) as the serving cell of the relay, and/or may evaluate a second condition (e.g., otherwise).

The information received from the relay WTRU may include one or more measurement values (e.g., RSRP, RSRQ, RSSI). In some embodiments, a remote WTRU may evaluate one or more configured conditions associated with the conditional reconfiguration. The remote WTRU may evaluate the one or more configured conditions associated with the conditional reconfiguration depending on the measurement values provided by the relay WTRU (e.g., in the discovery message). For example, if the measurement of the Uu RSRP measured by the relay WTRU and/or transmitted in the discovery message is in a first configured range, the remote WTRU may evaluate a first condition, if the measurement is instead in a second configured range, the remote WTRU may evaluate a second condition, and so on. The measurement values may include, for example, the Uu measurements determined at the relay WTRU (e.g., RSRP, RSRQ, RSSI, etc.).

A relay WTRU may determine information to transmit to the remote WTRU. A relay WTRU may generate information to transmit (e.g., in discovery message). The WTRU may generate information to transmit differently depending on one or more factors that may be configured/predefined at the relay. The one or more factors may be derived by one skilled in the art from the remote WTRU behavior, described herein. The one or more factors may include, but are not limited to, any of the following: an explicit NW configuration (e.g., in dedicated signaling or SIB); Uu measurements; a relay load indicator; a relay mobility indicator; and/or CBR measurements.

The one or more factors may include an explicit NW configuration (e.g., in dedicated signaling or SIB). In some embodiments, the network may provide to the relay WTRU a value and/or index to be transmitted in discovery. The relay WTRU may transmit an index and/or value in discovery which is given by an IE broadcast by the cell in system information block (SIB). Additionally, or alternatively, the one or more factors may include one or more Uu measurements. In some embodiments, a relay WTRU may be configured to transmit a first value and/or index if the Uu measurements are in a first range, a second value and/or index if the Uu measurements are in a second range, etc. Measurements may include one or more of Uu RSRP, RSRQ, RSSI, etc.

Additionally, or alternatively, the one or more factors may include relay load. In some embodiments, a relay WTRU may be configured to transmit a first value or index if the relay load is in a first range, a second value or index if the load is in a second range, etc. The relay WTRU may measure load based on one or more of the following: the relaying buffer status (e.g., packets/bytes pending transmission in the UL or/and DL at the relay WTRU), the number of attached remote WTRUs, the number of logical channels (LCHs) to be relayed, the type of LCHs/bearers being relayed, etc.

Additionally, or alternatively, the one or more factors may include relay mobility. In some embodiments, a relay WTRU may be configured to transmit one or more of a first value and/or index for a first level of mobility/speed at the relay, a second value and/or index for a second level of mobility/speed, etc. Additionally, or alternatively, the one or more factors may include CBR measurements. In some embodiments, a relay WTRU may be configured to transmit one or more of a first value or index for a CBR that is measured to be in a first range, a second value or index for a CBR that is measured to be in a second range, etc.

A remote WTRU may determine the conditional reconfiguration condition to use based on measurements at the remote WTRU (e.g., measurements associated with the relay). In some scenarios, a remote WTRU may select one or more conditional reconfiguration conditions. The remote WTRU may select the one or more of conditional reconfiguration conditions based on a measurement performed at the remote WTRU. For example, the remote WTRU may evaluate a first condition to determine one or more of whether conditional reconfiguration is performed if a first measured condition is met, whether a second condition if a second measured condition is met, and so on.

The remote WTRU may use any or a combination of the following measurements and/or measurements described herein to determine which conditional reconfiguration condition to evaluate for a specific target: measurements of CBR; measurements of CR; sensing results; sidelink HARQ feedback; and/or mobility measurements. The WTRU may use one or more measurements of channel busy ratio (CBR) to determine which conditional reconfiguration condition to evaluate for a specific target. In some embodiments, a remote WTRU may be configured with one or more conditions. The one or more conditions may be associated with conditional reconfiguration to a target (e.g., a specific target). The one or more conditions (e.g., each condition) may be associated with a range of measured CBR. For example, a remote WTRU may evaluate one or more of a first configured condition if the measured CBR is within a first range of values, a second condition if the CBR is within a second range of values, etc.

The WTRU may use one or more measurements of channel occupancy ratio (CR) to determine which conditional reconfiguration condition to evaluate for a specific target. In some embodiments, a remote WTRU may be configured with one or more conditions associated with conditional reconfiguration to a target (e.g., a specific target). The one or more conditions may be associated with a range CR. For example, a remote WTRU may evaluate one or more of a first configured condition if the CR at the remote WTRU is within a first range of values, a second condition if the CR at the remote WTRU is within a second range of values, etc.

The WTRU may use one or more sensing results to determine which conditional reconfiguration condition to evaluate for a specific target. In some embodiments, a remote WTRU may be configured with one or more conditions associated with conditional reconfiguration to a target (e.g., a specific target). The one or more conditions may be associated with a given sensing result (e.g., determined by the remote WTRU transmitting in mode 2). For example, measurements may include one or more of the following: a number of available resources, a percentage of available resources, an amount of resources with interfering RSRP above a threshold, a number of times a threshold is increased to achieve x % available resources, how often preemption occurs at the remote WTRU, etc.

The WTRU may use one or more sidelink HARQ feedback to determine which conditional reconfiguration condition to evaluate for a specific target. In some embodiments, a remote WTRU may be configured with one or more conditions. The one or more conditions may be associated with conditional reconfiguration to a target (e.g., a specific target). The one or more conditions may be associated (e.g., may each be associated) with a set of results associated with one or more of sidelink HARQ feedback, the percentage of ACK/NACK, the percentage of transmissions not requiring HARQ feedback, etc.

The WTRU may use mobility to determine which conditional reconfiguration condition to evaluate for a specific target. In some embodiments, a remote WTRU may be configured with one or more conditions. The one or more conditions may be associated with conditional reconfiguration to a target (e.g., a specific target). The one or more conditions may be associated (e.g., each condition may be associated) with a certain level/range of mobility state of the remote WTRU (e.g., use first condition if the WTRU is in a low mobility state, use second condition if the WTRU is in high mobility state, etc.)

A remote WTRU may prioritize reconfiguration candidates. A remote WTRU may prioritize one reconfiguration candidate over another. For example, the remote WTRU may prioritize a reconfiguration candidate over another based on one or more criteria determined at the remote WTRU and/or indicated by a relay WTRU. In some scenarios, remote WTRU actions may be associated with prioritization of a reconfiguration candidate.

Prioritization (e.g., determining the priority) of a reconfiguration candidate may include one or more of the following steps. Prioritization of a reconfiguration candidate may include selecting one or more reconfiguration candidate over another one or more reconfiguration candidate (e.g., deciding to execute a conditional reconfiguration associated with one candidate rather than another), when the conditions associated with both candidates are triggered. Prioritization of a reconfiguration candidate may include deciding to add an a positive/negative bias/offset to the measurements associated to one or more of the candidates (e.g., when there are multiple reconfiguration candidates). Prioritization of a reconfiguration candidate may include monitoring the conditions associated with one or more reconfiguration candidates with different periodicities (e.g., performing measurements associated with one candidate more/less frequently than another). Prioritization of a reconfiguration candidate may include using one conditional reconfiguration timer over another. Prioritization of a reconfiguration candidate may include determining which conditional reconfiguration candidate to maintain following a path switch occurring as a result of an explicit path switch command, and/or as a result of triggering a successful conditional reconfiguration (e.g., if the remote WTRU can only maintain a maximum number of candidates/reconfigurations following a mobility event). Prioritization of a reconfiguration candidate may include determining whether to continue performing measurements associated with conditional reconfiguration following mobility. Prioritization of a reconfiguration candidate may include determining whether a reconfiguration candidate should be considered when performing CHO instead of re-establishment after an RLF. Additionally, or alternatively, prioritization of a reconfiguration candidate may include determining the behavior of the WTRU upon the fulfillment of the triggering conditions of a conditional reconfiguration when another conditional reconfiguration is currently being executed.

Criteria may be used for prioritization of a reconfiguration candidate. A remote WTRU may use one or more criteria for prioritizing one reconfiguration candidate over another, and/or may determine whether a reconfiguration candidate is prioritized or not. Criteria may include but are not limited to a time duration between the reception of a conditional reconfiguration by the remote WTRU and the fulfillment of the corresponding triggering conditions; whether the reconfiguration candidate is a cell or a relay; information transmitted by the relay WTRU; and/or combinations of criteria.

A remote WTRU may use a time duration between the reception of a conditional reconfiguration by the remote WTRU, and the fulfillment of the corresponding triggering conditions, for determining the relative priorities of one or more reconfiguration candidates. In some scenarios, a remote WTRU may determine the priority of a reconfiguration candidate based on the time elapsed between the reception of the reconfiguration and the time at which the triggering conditions are fulfilled. For example, the WTRU may be provided with multiple conditional reconfiguration targets (e.g., target relay WTRUs). If the trigger conditions associated with multiple targets are met (e.g., either simultaneously, or within some time period), the WTRU may select the target that was configured later. If the trigger conditions associated with multiple targets are met, the WTRU may select among the targets which were configured not earlier than a configured time duration/threshold (e.g., a certain configured time duration/threshold).

Additionally, or alternatively, A remote WTRU may consider whether the reconfiguration candidate is a cell or a relay when determining the relative priorities of one or more reconfiguration candidates. In some scenarios, a remote WTRU may determine the priority of a reconfiguration candidate based on whether the candidate is a cell or a relay. For example, if the trigger conditions associated with multiple targets (e.g., cells and/or relays) are met, the remote WTRU may select a reconfiguration to be triggered to a cell rather than a relay. Alternatively, or additionally, if the trigger conditions associated with multiple targets are met, the remote WTRU may select a reconfiguration to be triggered to a relay rather than a cell. Alternatively, or additionally, the WTRU may be configured to prioritize a cell or relay. The WTRU may be configured to prioritize a cell or relay based on conditions (e.g., other conditions) herein (e.g. CBR, measurements, etc.).

A remote WTRU may determine the relative priorities of one or more reconfiguration candidates based on information transmitted by the relay WTRU (e.g., as described herein). In some scenarios, a remote WTRU may determine the priority of a reconfiguration candidate based on criteria related to the information that is transmitted by the relay WTRU (e.g., in the discovery message). For example, a relay WTRU with lower mobility (e.g., or indicating a lower level of mobility) may be given higher priority. A relay WTRU moving with a similar speed/direction as the remote WTRU may be prioritized. In some embodiments, a relay WTRU with lower CBR measurements may be given higher priority. A relay WTRU with better Uu RSRP measurements may be given higher priority. A relay WTRU with lower load may be given higher priority. A remote WTRU may determine the priority of a reconfiguration candidate based on criteria related to the information that is transmitted by the relay WTRU, for example, a relay WTRU which does not result in any cell change as a result of the reconfiguration, or where the cell change may be within a configured cell group.

In some scenarios, a remote WTRU may use a combination of criteria described herein for determining the relative priorities of one or more reconfiguration candidates. For example, the time threshold under which a relay is prioritized may further depend on the mobility of the relay, as indicated in the message from the relay to the remote WTRU. The terms target and candidate may be used interchangeably as herein.

What is claimed is:

1. A remote wireless transmit/receive unit (WTRU) comprising:
a processor configured to:
receive configuration information, the configuration information comprising an indication of a first path switch condition and an indication of a second path switch condition;
receive a discovery transmission from a relay WTRU, the discovery transmission comprising an indication of whether to apply the first path switch condition or the second path switch condition; and
determine to perform a path switch to the relay WTRU, wherein the path switch is performed using the first path switch condition or the second path switch condition based on the indication provided via the discovery transmission.

2. The remote WTRU of claim 1, wherein the first path switch condition or the second path switch condition comprises a threshold.

3. The remote WTRU of claim 2, wherein the first path switch condition comprises a first reference signal received power (RSRP) threshold, a first reference signal received quality (RSRQ) threshold, or a first reference signal strength indicator (RSSI) threshold; and
wherein the second path switch condition comprise a second RSRP threshold, a second RSRQ threshold, or a second RSSI threshold.

4. The remote WTRU of claim 1, wherein the indication comprises an explicit indication for the remote WTRU to use the first path switch condition or the second path switch condition.

5. The remote WTRU of claim 1, wherein the indication is associated with a load of the relay WTRU, a measurement of a Uu interface associated with the relay WTRU, a mobility state of the relay WTRU, or a channel busy ratio (CBR) measurement of the relay WTRU.

6. The remote WTRU of claim 5, wherein the measurement comprises a channel busy ratio (CBR) measurement.

7. The remote WTRU of claim 1, wherein the processor is configured to determine whether to apply the first path switch condition or the second path switch condition based on a measurement performed at the remote WTRU.

8. The remote WTRU of claim 1, wherein the processor is configured to determine whether to apply the first path switch condition or the second path switch condition based on sensing performed at the remote WTRU.

9. The remote WTRU of claim 1, wherein the processor is configured to determine whether to apply the first path switch condition or the second path switch condition based on hybrid automatic repeat request (HARQ) feedback at the remote WTRU.

10. The remote WTRU of claim 1, wherein the processor is configured to determine whether to apply the first path switch condition or the second path switch condition based on a mobility state of the remote WTRU.

11. A method to be performed by a remote wireless transmit/receive unit (WTRU), the method comprising:
receiving configuration information, the configuration information comprising an indication of a first path switch condition and an indication of a second path switch condition;
receiving a discovery transmission from a relay WTRU, the discovery transmission comprising an indication of whether to apply the first path switch condition or the second path switch condition; and
determining to perform a path switch to the relay WTRU, wherein the path switch is performed using the first path switch condition or the second path switch condition based on the indication provided via the discovery transmission.

12. The method of claim 11, wherein the first path switch condition or the second path switch condition comprises a threshold.

13. The method of claim 12, wherein the first path switch condition comprises a first reference signal received power (RSRP) threshold, a first reference signal received quality (RSRQ) threshold, or a first reference signal strength indicator (RSSI) threshold; and
wherein the second path switch condition comprise a second RSRP threshold, a second RSRQ threshold, or a second RSSI threshold.

14. The method of claim 11, wherein the indication comprises an explicit indication for the remote WTRU to use the first path switch condition or the second path switch condition.

15. The method of claim 11, wherein the indication is associated with a load of the relay WTRU, a measurement of a Uu interface associated with the relay WTRU, a mobility state of the relay WTRU, or a channel busy ratio (CBR) measurement of the relay WTRU.

16. The method of claim 15, wherein the measurement comprises a channel busy ratio (CBR) measurement.

17. The method of claim 11, further comprising determining whether to apply the first path switch condition or the second path switch condition based on a measurement performed at the remote WTRU.

18. The method of claim 11, further comprising determining whether to apply the first path switch condition or the second path switch condition based on sensing performed at the remote WTRU.

19. The method of claim 11, further comprising determining whether to apply the first path switch condition or the second path switch condition based on hybrid automatic repeat request (HARQ) feedback at the remote WTRU.

20. The method of claim 11, further comprising determining whether to apply the first path switch condition or the second path switch condition based on a mobility state of the remote WTRU.
